(19) United States
(12) Patent Application Publication
(10) Pub. No.: US 2006/0229876 A1
(43) Pub. Date: Oct. 12, 2006

(54) Method, apparatus and computer program providing a multi-speaker database for concatenative text-to-speech synthesis

(75) Inventors: Andrew S. Aaron, Ardsley, NY (US); Ellen M. Eide, Tarrytown, NY (US); Wael M. Hamza, Yorktown Heights, NY (US); Michael A. Picheny, White Plains, NY (US); Charles T. Rutherfoord, Delray Beach, FL (US); Zhi Wei Shuang, Beijing (CN); Maria E. Smith, Davie, FL (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 11/101,223

(22) Filed: Apr. 7, 2005

(51) Int. Cl. G10L 13/00

(52) U.S. Cl. 704/263

(57) ABSTRACT

A method, apparatus and a computer program product to generate an audible speech word that corresponds to text. The method includes providing a text word and, in response to the text word, processing pre-recorded speech segments that are derived from a plurality of speakers to selectively concatenate together speech segments based on at least one cost function to form audio data for generating an audible speech word that corresponds to the text word. A data structure is also provided for use in a concatenative text-to-speech system that includes a plurality of speech segments derived from a plurality of speakers, where each speech segment includes an associated attribute vector each of which is comprised of at least one attribute vector element that identifies the speaker from which the speech segment was derived.

### TECHNICAL FIELD

These teachings relate generally to text-to-speech (TTS) systems and methods and, more particularly, relate to concatenative TTS (CTTS) systems and methods.

### BACKGROUND

Conventional CTTS systems use a database of speech segments (e.g., phonemes, syllables, and/or entire words) recorded from a single speaker to select speech segments to concatenate based on some input text string. In order to achieve high-quality synthetic speech, however, a large amount of data need be collected from the single speaker; thus making the development of such a database time-consuming and costly.

Reference with regard to some conventional approaches may be had, for example, to U.S. Pat. No. 6,725,199 B2, “Speech Synthesis Apparatus and Selection Method”, Brittan et al.; U.S. Pat. No. 5,878,393, “High Quality Concatenative Reading System”, Hata et al.; and U.S. Pat. No. 5,860,064, “Method and Apparatus for Automatic Generation of Vocal Emotion in a Synthetic Text-to-Speech System”, Caroline G. Henton. For example, the system described in U.S. Pat. No. 5,878,393 employs a dictionary of sampled sounds, where the dictionary may include separate dictionaries of sounds sampled at different sampling rates. The dictionary may also store all pronunciation variants of a word for each of a plurality of prosodic environments.

New domains for deploying text-to-speech invariably arise, usually accompanied by a desire to supplement the database of recordings used to build a CTTS system with additional data corresponding to words, phrases and/or sentences which are highly relevant to the new domain, such as specific company names or technical phrases not present in the original script.

However, in the event that the original speaker whose voice was recorded and sampled to populate the dictionary is no longer available to make an additional recording, a new speaker may be required to re-record all of the original script, in addition to the new domain-specific script. Such a process would not be efficient for a number of reasons.

### SUMMARY OF THE PREFERRED EMBODIMENTS

The foregoing and other problems are overcome, and other advantages are realized, in accordance with the presently preferred embodiments of these teachings.

In one aspect thereof this invention provides a method and an apparatus to generate an audible speech word that corresponds to text. The method includes providing a text word and, in response to the text word, processing pre-recorded speech segments that are derived from a plurality of speakers to selectively concatenate together speech segments based on at least one cost function to form audio data for generating an audible speech word that corresponds to the text word.

In another aspect thereof this invention provides a data structure embodied with a computer readable medium for use in a concatenative text-to-speech system. The data structure includes a plurality of speech segments that are derived from a plurality of speakers, where each speech segment includes an associated attribute vector each of which is comprised of at least one attribute vector element that identifies the speaker from which the speech segment was derived.

In preferred embodiments of this invention the speech segments are pre-recorded by a process that comprises designating one speaker as a target speaker, examining an input speech segment to determine if it is similar to a corresponding speech segment of the target speaker and, if it is not, modifying at least one characteristic of the input speech segment, such as a temporal and/or a spectral characteristic, so as to make it more similar to the corresponding speech segment of the target speaker. The preferred embodiments of this invention also enable the pooling of speech segments of the target speaker and the possibly modified auxiliary speakers to form a larger database from which to draw speech segments for concatenative text-to-speech synthesis.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is a block diagram of a CTTS system in accordance with embodiments of this invention;

FIG. 2 is a logic flow diagram that depicts a method in accordance with the embodiments of this invention;

FIG. 3 illustrates an exemplary cost matrix for a “speaker” element of an attribute vector; and

FIG. 4 is another view of the method shown in FIG. 2.

### DETAILED DESCRIPTION OF THE PREFERRED EMBODIMENTS

In accordance with exemplary embodiments of this invention a system and method operate to combine speech segment databases from several speakers to form a larger combined database from which to select speech segments at run-time.

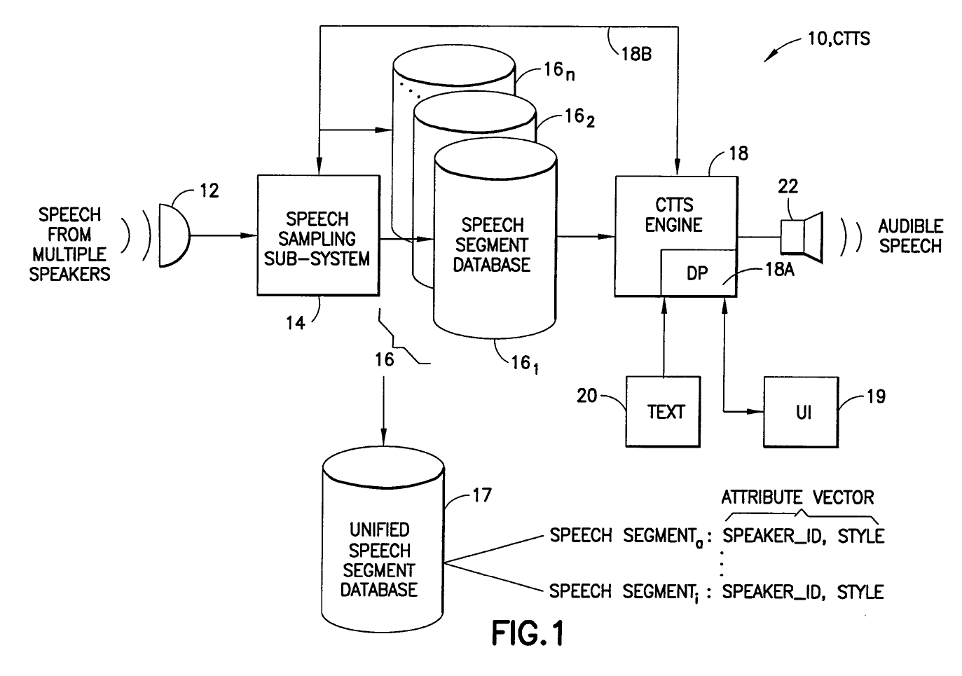

Referring to FIG. 1, an exemplary CTTS system 10 in accordance with examples of this invention includes a speech transducer, such as a microphone 12, having an output coupled to a speech sampling sub-system 14. The speech sampling sub-system 14 may operate at one or at a plurality of sampling rates, such as 11 kHz, 22 kHz and/or 44.1 kHz. The output of the speech sampling sub-system 14 is stored in a memory database 16 for use by a CTTS engine 18 when converting input text 20 to audible speech that is output from a loudspeaker 22 or some other suitable output speech transducer. The database 16 may contain data representing phonemes, syllables, or other component parts of uttered speech, or it may contain, less preferably, entire words. The CTTS engine 18 is assumed to include at least one data processor (DP) 18A that operates under control of a stored program to execute the functions and methods in accordance with embodiments of this invention. The CTTS system 10 may be embodied in, as non-limiting examples, a desk top computer, a portable computer, a work station, a main frame computer, or it may be embodied on a card or module and embedded within another system. The CTTS engine 18 may be implemented in whole or in part as an application program executed by the DP 18A.

In accordance with exemplary embodiments of this invention the database 16 may actually be viewed as a plurality of separate databases 16₁, 16₂, . . . , 16ₙ each storing sampled speech segments recorded from one of a plurality of speakers, for example two, three or more speakers who read the same or different text words, phrases and/or sentences. Assuming by way of example, and not as a limitation, that the sampled speech segments of an original speaker are stored in the database 16₁, then additional speech segment data stored in the databases 16₂-16ₙ may be derived from one or more auxiliary speakers who naturally sound similar (that is, have similar spectral characteristics and pitch contours) to some original speaker, or the additional speech segment data may be derived from one or more auxiliary speakers who sound dissimilar to the original speaker, but whose pitch and/or spectral characteristics are modified by speech sampling sub-system 14 using suitable signal processing so that the resulting speech sounds similar to the original speaker. For those speakers who are processed to sound like the original speaker, the processed speech database 16 may be combined with the other databases to form a single database, while for speakers who naturally sound like the original speaker their unprocessed speech segment data may be combined with the data from the other speakers. After combining data from two or more speakers, it is preferred that one large (unified) database 17 is formed, which allows for higher quality speech output.

It is thus preferred to employ one or more signal processing techniques to transform the input speech from two or more speakers in order to pool data from the several speakers to sound as if it all originated from the same speaker. Either manual hand-tuning or automatic methods of finding the appropriate transformation may be used for this purpose of populating the unified speech segment database 17.

The CTTS 10 may then be built from a combination of the optionally processed supplemental databases 16₂, . . . , 16ₙ and the original database 16, for the purpose of enhancing the quality of the output speech. Note that the original, typically preferred speaker need not be present when recording and storing the speech annunciated by the other (auxiliary) speakers.

The foregoing process may be of particular value when updating a legacy CTTS system to include new words, phrases and/or sentences which are highly relevant to a new domain or context for the CTTS system. In this case the legacy speaker is naturally the “target” speaker, and the other speaker or speakers from whom the additional data come are naturally the “auxiliary” speakers. However, it should be appreciated that in other embodiments the CTTS system 10 may be designed from the start to include the multiple speech segment databases 16₁, 16₂, . . . , 16ₙ and/or the unified speech segment database 17. In this latter case it may still be the case that one of the speakers is a target speaker, or one having a most preferred speech sound for a given application of the CTTS system 10, to which the other speakers are compared and their speech modified as necessary to more closely resemble the speech of the target speaker.

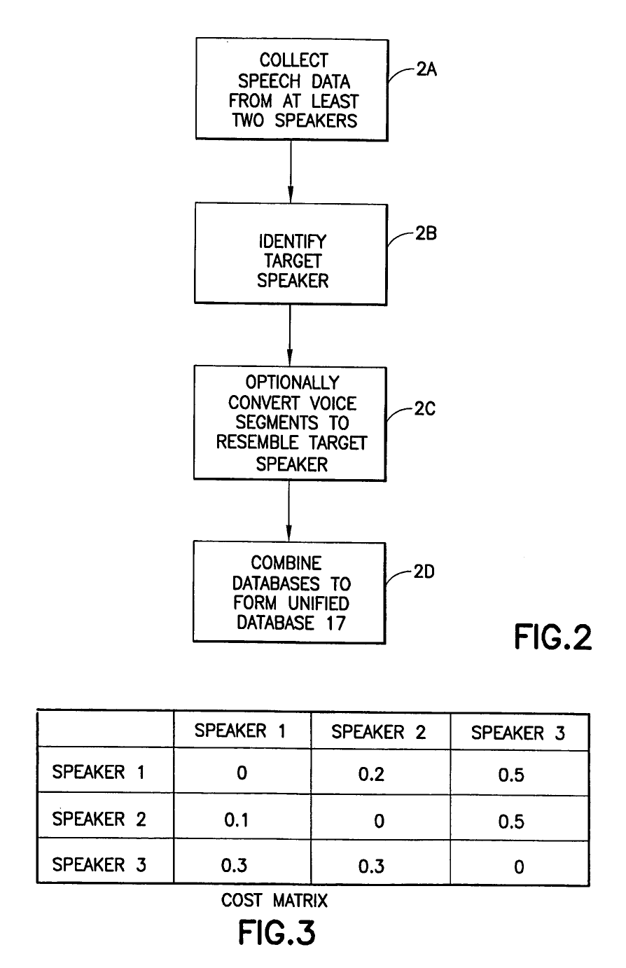

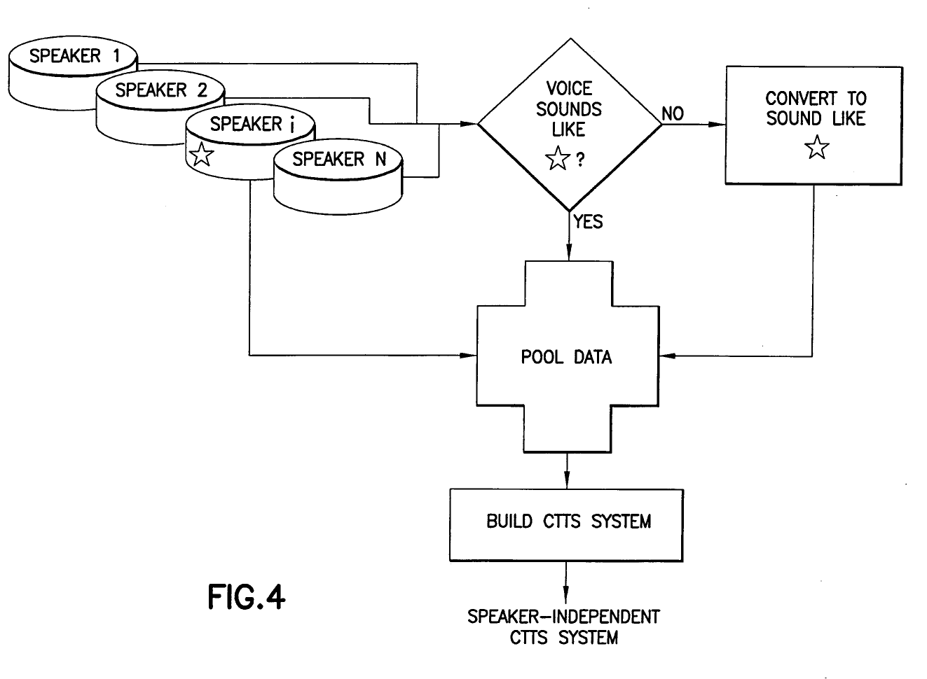

Referring to FIG. 2 and to FIG. 4, a method in accordance with embodiments of this invention performs the following operations. At Block 2A the CTTS 10 collects speech data from at least two speakers. At Block 2B the CTTS engine 18, possibly in cooperation with a user of the CTTS 10 via some suitable user interface (UI) 19, identifies a voice as being that of the “target speaker”, shown designated with a star in FIG. 4. Preferably the CTTS 10 uses the voice of one of the speakers for whom a database 16 has been collected, but it may optionally be any desired voice. That is, the voice of the “target speaker” need not be one of the actual plurality of speakers. At Block 2C the CTTS engine 18 optionally converts the data recorded from supplemental (non-target) speaker(s) so as to sound like the voice of the target speaker. This process can include pitch and/or temporal modification, or any suitable type of modification of the digitized speech samples. This particular operation may be considered as being optional, as the voice of a particular supplemental speaker may naturally sound sufficiently like the voice of the target speaker so as not to require modification. At Block 2D the CTTS engine 18 combines or pools data from one or more supplemental speakers with the target speaker's data, and at Block 2E builds and operates the CTTS 10 using the combined data in the database 17. This last operation may optionally include the use of a term in a cost function for selecting speech segments that prefers data from the original speaker and/or some of the supplemental speakers based on the quality of the transformed data. An end result is the provision of the substantially speaker-independent CTTS system 10 in accordance with embodiments of this invention

In one non-limiting example of the use of the CTTS 10 two female speakers were found to be very close in pitch and spectral characteristics, and their respective speech segment databases 16 were combined or pooled without normalization. A third female speaker with markedly low pitch was processed using commercially available third party software, such as one known as Adobe® Audition™ 1.5, to raise the average pitch so as to be in the same range of pitch frequencies as the other two female speakers. The third female speaker's processed data were merged or pooled with the data of the other two speakers.

In accordance with non-limiting embodiments of this invention, during the process of building the pooled dataset stored in the database 17 by the CTTS engine 18 (indicated by the signal line or bus 18B shown in FIG. 1), each speech segment in the database 17 is labeled by an attribute vector that conveys information about that segment. In accordance with the embodiments of this invention one element of the attribute vector is the identity of the speaker who originally spoke that segment.

During synthesis the input speech segment data, which is preferably, but not as a limitation, in the form of an extended Speech Synthesis Markup Language (SSML) document (http://www.w3.org/TYR/2004/REC-speech-synthesis-20040907/), are processed by an XML parser. The extended SSML tags are used to form a target attribute vector, analogous to one used in a voice-dataset-building process to label the speech segments. In this case one element of the target attribute vector is the identity of the target speaker (Speaker_ID, as in FIG. 1). Another element of the target attribute vector may be the expressive style (Style, as in FIG. 1) of the speech segment, such as “conveying good news,” “conveying bad news,” “asking a question,” or “neutral”, as was considered in Eide E. et al., “A Corpus-based Approach to <Ahem/> Expressive Speech Synthesis”, Proceedings of the 5th ISCA Speech Synthesis Workshop, Pittsburgh, Pa., USA, Jun. 14-16, 2004, and in Hamza, W. et al., “The IBM Expressive Speech Synthesis System”, Proceedings ICSLP, 2004, Jeju Island, Korea.

It can thus be appreciated than an aspect of this invention is a data structure that is stored in a computer readable medium for use in a concatenative text-to-speech system, where the data structure is comprised of a plurality of speech segments derived from a plurality of speakers, where each speech segment includes an associated attribute vector each of which is comprised of at least one attribute vector element that identifies the speaker from which the speech segment was derived. An additional element may be one that indicates a style of the speech segment. A speech segment may be derived from a speaker by simply sampling, digitizing and partitioning spoken words into some units, such as phonemes or syllables, with little or no processing or modification of the speech segments. Alternatively, a speech segment may be derived from a speaker by sampling, digitizing, spectrally or otherwise processing the digitized speech samples, such as by performing pitch enhancement or some other spectral modification, and/or by performing temporal modification, and partitioning the processed speech sample data into the units of interest.

An attribute cost function C(t,o) may be used to penalize the use of a speech segment labeled with an attribute vector o when the target is labeled by attribute vector t. A cost matrix Cᵢ is preferably defined for each element i in the attribute vector. An example of such a cost matrix is shown in FIG. 3 for the Speaker_ID element of the target attribute vector. The cost matrix specifies, for example, that the cost is 0.5 when using a speech segment from Speaker 2 when Speaker 3 is the target speaker.

Asymmetries in the cost matrix may arise because of different sizes of datasets. For example, if one speaker has a very large dataset compared to another speaker, it may be preferred to penalize more heavily the use of speech segments from the smaller dataset when the speaker with the large dataset is the target, and to penalize less heavily the use of segments from the large dataset when the speaker corresponding to the small dataset is the target.

A desired end result of the foregoing processes is that an audible speech word that is output from the loudspeaker 22 may be comprised of constituent voice sounds, such as phonemes or syllables, that are actually derived from two or more speakers and that are selectively concatenated together based on at least one cost function.

The embodiments of this invention may be implemented by computer software executable by the data processor 18A of the CTTS engine 18, or by hardware, or by a combination of software and hardware. Further in this regard it should be noted that the various blocks of the logic flow diagram of FIG. 2 may represent program steps, or interconnected logic circuits, blocks and functions, or a combination of program steps and logic circuits, blocks and functions.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. For example, the use of other similar or equivalent speech processing and modification hardware and software may be attempted by those skilled in the art. Further, other types of cost functions and modifications of same may occur to those skilled in the art, when guided by these teachings. Still further, it can be appreciated that many CTTS systems will not include the microphone 12 and speech sampling sub-system 14, as once the database 16 is generated it can be provided in or on a computer-readable tangible medium, such as on a disk or in semiconductor memory, and need not be generated or even maintained locally. However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A method to generate an audible speech word that corresponds to text, comprising:
providing a text word; and
in response to the text word, processing pre-recorded speech segments that are derived from a plurality of speakers to selectively concatenate together speech segments based on at least one cost function to form audio data for generating an audible speech word that corresponds to the text word.

2. A method as in claim 1, where each pre-recorded speech segment comprises an attribute vector, and each attribute vector comprises a vector element that identifies the speaker from which the speech segment was derived.

3. A method as in claim 1, where each attribute vector further comprises another vector element that identifies a style of speech from which the speech segment was derived.

4. A method as in claim 1, where said speech segments are pre-recorded by a process that comprises designating one speaker as a target speaker, examining an input speech segment to determine if it is similar to a corresponding speech segment of the target speaker and, if it is not, modifying at least one characteristic of the input speech segment so as to make it more similar to the corresponding speech segment of the target speaker.

5. A method as in claim 4, where modifying comprises altering at least one of a temporal or a spectral characteristic of the input speech segment.

6. A method as in claim 1, where a speech segment comprises at least one of a phoneme, a syllable, and a word.

7. A concatenative text-to-speech system comprising: a data processor coupled to a memory that stores a database of speech segments derived from a plurality of speakers, said data processor being responsive to an input text word to selectively concatenate together speech segments from said database based on at least one cost function to form audio data for generating an audible speech word that corresponds to the text word.

8. A concatenative text-to-speech system as in claim 7, where each pre-recorded speech segment comprises an attribute vector, and each attribute vector comprises a vector element that identifies the speaker from which the speech segment was derived.

9. A concatenative text-to-speech system as in claim 7, where each attribute vector further comprises another vector element that identifies a style of speech from which the speech segment was derived.

10. A concatenative text-to-speech system as in claim 7, where said speech segments are pre-recorded by a process that comprises designating one speaker as a target speaker, examining an input speech segment to determine if it is similar to a corresponding speech segment of the target speaker and, if it is not, modifying at least one characteristic of the input speech segment so as to make it more similar to the corresponding speech segment of the target speaker.

11. A concatenative text-to-speech system as in claim 10, where said system modifies a speech segment by using at least one of a temporal or a spectral characteristic of the input speech segment.

12. A concatenative text-to-speech system as in claim 7, where a speech segment comprises at least one of a phoneme, a syllable, and a word.

13. A data structure embodied in a computer readable medium for use in a concatenative text-to-speech system, comprising a plurality of speech segments derived from a plurality of speakers, where each speech segment includes an associated attribute vector each of which is comprised of at least one attribute vector element that identifies the speaker from which the speech segment was derived.

14. A data structure as in claim 13, where each attribute vector is further comprised of a style element.

15. A data structure as in claim 13, where at least some speech segments are derived from a speaker by sampling, digitizing and partitioning spoken words into word units.

16. A data structure as in claim 15, where a word unit comprises at least one of a phoneme, a syllable, and a word.

17. A data structure as in claim 15, where at least some speech segments are derived from a speaker by sampling, digitizing, processing the digitized speech samples, and partitioning the processed speech samples into word units.

18. A program storage device readable by machine and tangibly embodying a program of instructions executable by the machine to operate a concatenative text-to-speech apparatus, comprising operations of: responsive to a text word, processing pre-recorded speech segments that are derived from a plurality of speakers to selectively concatenate together speech segments based on at least one cost function; and forming audio data for generating an audible speech word that corresponds to the text word, where each pre-recorded speech segment comprises an attribute vector, and each attribute vector comprises a vector element that identifies the speaker from which the speech segment was derived.

19. A program storage device as in claim 18, where said speech segments are pre-recorded by operations that comprise designating one speaker as a target speaker, examining an input speech segment to determine if it is similar to a corresponding speech segment of the target speaker and, if it is not, modifying at least one temporal or spectral characteristic of the input speech segment so as to make it more similar to the corresponding speech segment of the target speaker.
